(19) United States
(12) Patent Application Publication
(10) Pub. No.: US 2018/0300515 A1
(43) Pub. Date: Oct. 18, 2018

(54) METHOD AND APPARATUS FOR ACCELERATED DATA DECODING

(71) Applicant: SYMBOL TECHNOLOGIES, LLC, Lincolnshire, IL (US)

(72) Inventor: Yong Deng, Quebec (CA)

(21) Appl. No.: 15/489,436

(22) Filed: Apr. 17, 2017

(51) Int. Cl. G06K 7/10; G06K 7/14; G06K 19/06

(52) U.S. Cl. CPC G06K 7/10811; G06K 7/1413; G06K 7/10881; G06K 7/10732; G06K 19/06028

(57) ABSTRACT

A method of decoding at a data capture device includes concurrently controlling a plurality of image sensors of the data capture device to capture respective images. At least one of the images includes an indicium encoding data. The method further includes storing the images in a memory of the data capture device, and concurrently processing the plurality of images by: retrieving each of the images from the memory; and performing respective decode operations on the images. The method further includes detecting that the data has been successfully decoded from one of the images via one of the decode operations; and responsive to the detecting, interrupting the remaining decode operations.

### BACKGROUND

Data capture devices, such as handheld barcode scanners, may be employed under a variety of conditions, at least some of which may lead to reduced scanning accuracy, reduced scanning speed, or both.

### BRIEF DESCRIPTION OF THE SEVERAL VIEWS OF THE DRAWINGS

FIG. 1 is a schematic of a data capture device.

FIG. 2 is a block diagram of certain internal hardware components of the data capture device of FIG. 1.

FIG. 3 is a block diagram of certain internal components of the data capture device of FIG. 1.

FIG. 4 is a flowchart of a method of decoding at a data capture device.

FIG. 5 is a set of images captured for decoding in the performance of the method of FIG. 4.

FIG. 6 is a partial block diagram of certain internal components of the data capture device of FIG. 1 during the performance of the method of FIG. 4.

FIG. 7 is a schematic of an indication of decoding success presented by the data capture device of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

### DETAILED DESCRIPTION

Data capture devices, such as handheld barcode scanners, in-counter or countertop barcode scanners and the like, may be deployed in a variety of environments, including warehousing applications, point-of-sale applications and the like. Some of the above-mentioned scanners are based on digital imaging technology, and thus include an image sensor, such as a charge-coupled device (CCD) or complementary metal-oxide semiconductor (CMOS) sensor. Responsive to an input command, such as a trigger activation on a handheld scanner, the image sensor captures one or more frames of image data. Processing components of the data capture device are configured to identify and decode machine-readable indicia in the image data, such as barcodes of various types affixed to objects in the field of view of the image sensor.

Several factors can impede the identification and decoding of an indicium in a frame of image data. For example, the orientation of the object may result in significant variations in the quantity of light reflected from the surface bearing the indicium toward the image sensor. Thus, some frames captured by the image sensors may be too dark, or too bright, to decode. As a further example, the distance between the article and the image sensor may vary, resulting in certain frames that are out of focus and cannot be decoded.

Conventional data capture devices attempt to address the above-mentioned difficulties in various ways. Certain data capture devices project aiming light patterns and capture a frame of image data, employing the light pattern as depicted in the captured frame to assess the distance of the object and calibrate focal length for a subsequent frame capture. Other data capture devices employ multiple image sensors; for example, two image sensors may be provided with two different focal lengths or exposure settings, and an aiming frame as mentioned above may be captured and processed to determine the distance to the article being scanned, or the exposure of the article. The device may then select the appropriate sensor to activate in order to capture image data to be decoded. In practice, several of the above-mentioned aiming frames are typically necessary to accurately assess distance and/or exposure.

The attempts to increase decoding accuracy summarized above introduce additional complexity, such as the need for hardware and software components employed to switch between multiple image sensors, and/or capture and process aiming frames. Further, these attempts may require the data capture device to capture and decode a number of successive frames. Each frame requires a certain amount of time to decode (e.g. about 20 milliseconds in some examples) before the device can begin decoding the next frame. Frames are typically decoded sequentially, for example by a single decoder process executed by a processor of the data capture device. Therefore, if several frames are captured and processed before the indicium is successfully decoded from one of those frames, perceptible delays between input commands (e.g. trigger activation) and successful decoded output may be experienced.

Examples disclosed herein are directed to a method of decoding at a data capture device, including concurrently controlling a plurality of image sensors of the data capture device to capture respective images. At least one of the images includes an indicium encoding data. The method further includes storing the images in a memory of the data capture device, and concurrently processing the plurality of images by: retrieving each of the images from the memory; and performing respective decode operations on the images. The method further includes detecting that the data has been successfully decoded from one of the images via one of the decode operations; and responsive to the detecting, interrupting the remaining decode operations.

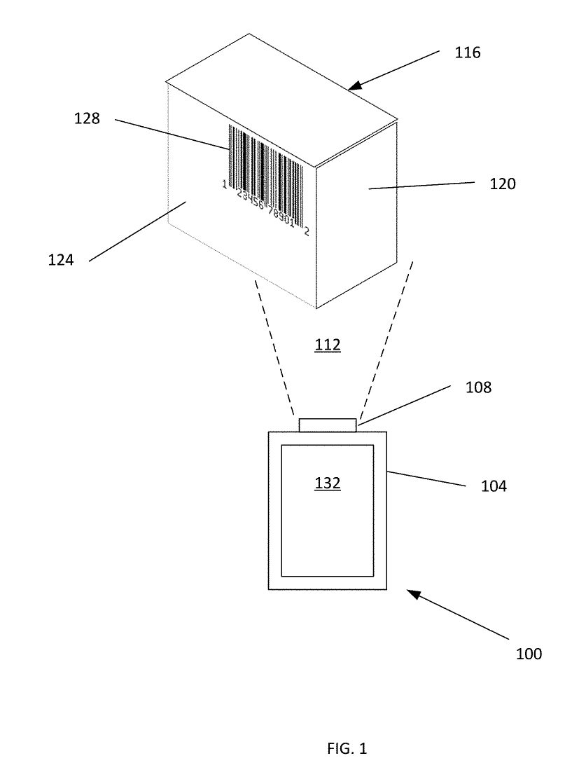

FIG. 1 depicts an example data capture device 100 in accordance with the teachings of this disclosure. The device 100 includes a housing 104 supporting the various other components discussed herein. In some examples, the housing 104 is a unitary structure supporting all other components of the device 100. In other examples, the housing 104 is implemented as two or more distinct (e.g. separable) housing components, such as a first component comprising a pistol-grip handle including a cradle configured to receive a second component comprising the housing of a smartphone, tablet computer, or the like. In the illustrated example, the data capture device 100 is implemented with a handheld form factor. In other examples, the data capture device 100 is implemented with an in-counter form factor, such as those employed in conjunction with point-of-sale terminals (e.g. in supermarkets and other retail locations).

The housing 104 supports a data capture module 108 configured to capture indicia within a field of view 112. As will be discussed below in greater detail, the data capture module 108 includes a plurality of image sensors such as one of, or a combination of, CCD and CMOS-based sensors. The data capture module 108 also includes any suitable one of, or any suitable combination of, light emitters, optical components such as lenses, mirrors and the like, enabling the data capture module 108 to capture images of objects in the field of view 112. Typically, at least one of the images includes an indicium affixed to an object in the field of view 112. The indicium, which may also be referred to as a barcode, encodes data according to any suitable symbology (e.g. Code 39, PDF417, Datamatrix and the like). The data capture device 100 is configured to decode the indicium. FIG. 1 illustrates an object in the form of a box 116 having two faces 120 and 124 within the field of view 112. As seen in FIG. 1, the face 120 does not bear any indicia, while the face 124 bears an indicium 128.

The data capture device 100 also includes a display 132 supported by the housing 104. The display 132 is a flat-panel display, such as an organic light-emitted diode-based display (e.g. an active-matrix OLED, or AMOLED, display). In other examples, however, the display 132 can be implemented with any of a wide variety of display technologies. In some examples, such as those in which the device 100 is implemented as an in-counter scanner (not shown), the display 132 is supported by the housing of a distinct device, such as a point-of-sale terminal, rather than by the housing 104 of the data capture device 100 itself.

The data capture device 100 is configured to render indications associated with indicia such as the indicium 128 on the display 132. The indications rendered on the display 132 include any one of, or any suitable combination of, the decoded data itself, an indication that the decoding of the data has succeeded or failed, and the like.

As will be described below, the data capture device 100 includes components to control the above-mentioned image sensors to capture a plurality of images and to process those images concurrently to decode the indicium included in at least one of the images, prior to rendering the above-mentioned indications on the display 132. The concurrent processing of the captured images according to the teachings herein may reduce or eliminate the perceptible delays between input commands (e.g. trigger activation) and successful decoded output that may be experienced in connection with conventional data capture devices, as discussed earlier.

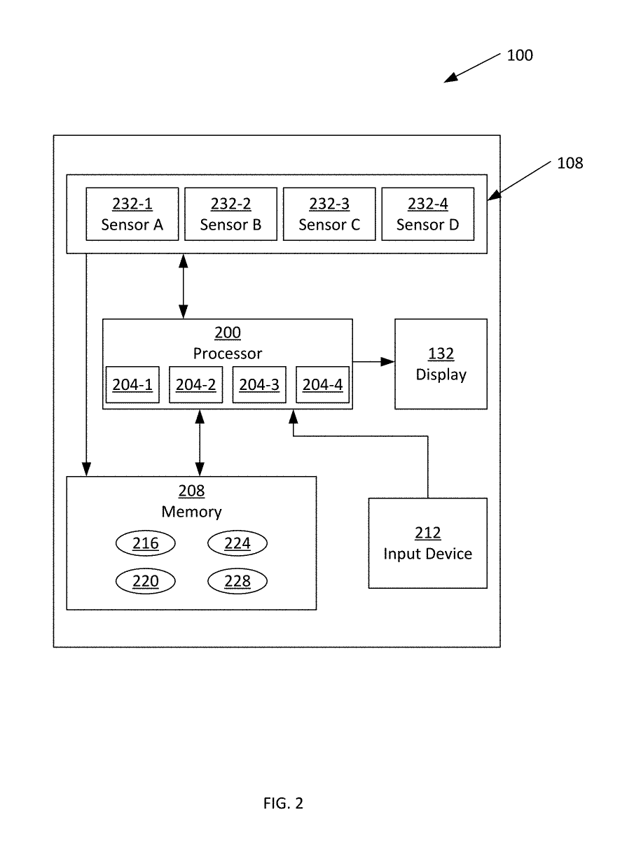

Referring to FIG. 2, a schematic diagram of certain internal components of the device 100 is shown. The device 100 includes a central processing unit (CPU), also referred to as a processor 200, having a plurality of processing units, also referred to herein as processor cores, 204-1, 204-2, 204-3 and 204-4 (collectively referred to as cores 204, and generically as a core 204). In the present example, the processor 200 is implemented as a single physical package including the cores 204 illustrated in FIG. 2. Four cores 204 are illustrated, although as few as two cores can be provided in other examples, and more than four can be provided in further examples. The physical package implementing the processor 200 also includes shared hardware components such as bus interfaces, on-board cache memory and the like. In other examples, the cores 204 are implemented on separate physical packages, and may therefore be referred to as distinct processors. In general, the processor 200 includes a plurality of independent processing units, each of which is able to perform certain image processing tasks (e.g. decoding indicia) independently of, and concurrently with, the other processing units.

The processor 200 is interconnected with a non-transitory computer readable storage medium, such as a memory 208. The memory 208 includes any suitable combination of volatile (e.g. Random Access Memory (RAM)) and non-volatile (e.g. read only memory (ROM), Electrically Erasable Programmable Read Only Memory (EEPROM), flash) memory.

The data capture device 100 also includes at least one input device 212 interconnected with the processor 200. The input device 212 is configured to receive input and provide data representative of the received input to the processor 200. In the present example, the input device 212 includes a trigger supported by the housing 104, in response to the actuation of which the processor 200 controls the data capture module 108 to initiate image capture. In some examples, the input device 212 also includes a touch screen integrated with the display 132. In other examples, the input device 212 includes other input hardware in addition to or instead of the above-mentioned input devices. Other examples of input hardware include a microphone, a keypad, a motion sensor, and the like.

The device 100 also includes at least one output device interconnected with the processor 200. The output device includes the display 132, mentioned above. In other examples (not shown), the output device also includes any one of, or any suitable combination of, a speaker, a notification LED, and the like.

The various components of the device 100 are interconnected, for example via one or more communication buses. The device 100 also includes a power source (not shown) for supplying the above-mentioned components with electrical power. In the present example, the power source includes a battery; in other examples, the power source includes a wired connection to a wall outlet or other external power source in addition to or instead of the battery.

The memory 208 stores a plurality of applications, each including a plurality of computer readable instructions executable by the processor 200. The execution of the above-mentioned instructions by the processor 200 causes the device 100 to implement certain functionality discussed herein.

In the present example, the memory 208 stores an imaging controller application 216, a scheduler application 220, a decoder application 224, and a renderer application 228. In brief, the imaging controller application 216, when executed by the processor 200, controls image sensors 232-1, 232-2, 232-3 and 232-4 of the data capture module 108, for example responsive to input such as a trigger activation, to capture images. In the illustrated example, the device 100 includes four image sensors 232, connected to the processor 200, for example via respective camera serial interfaces (CSIs). However, in other examples, the device 100 includes as few as two image sensors 232. In further examples, the device 100 includes a greater number of image sensors 232 than four; further, the number of image sensors 232 need not equal the number of processor cores 204.

Execution of the scheduler application 220 configures the processor 200 to perform various functions discussed herein, including spawning and interrupting instances of the decoder application 224 within the cores 204 of the processor 200, and allocating images for processing among the instances of the decoder application 224. The above-mentioned instances of the decoder application 224, meanwhile, configure the processor 200 (and more particularly, respective cores 204) to process the images captured by the image sensors 232 to decode indicia depicted in the images. To that end, the decoder application 224 includes any suitable decoding libraries corresponding to the symbologies present in the environment in which the data capture device 100 is configured to operate.

The renderer application 228 configures the processor 200 to control the display 132 to render various information, such as data generated by instances of the decoder application 224. In some examples, therefore, the renderer application 228 includes data defining user interface elements for presentation on the display 132, such as windows, icons and the like. The renderer application 228, in some examples, also includes video driver instructions executable by the processor 200. In other examples, the video driver instructions may be contained in a logically separate application.

In some examples, the imaging controller application 216, the scheduler application 220 and the renderer application 228 are components of an operating system stored in the memory 208. Various other logical divisions between the applications stored in the memory 208 are also contemplated. For example, two or more of the applications 216, 220, 224 and 228 can be combined in a single application providing the functionality of both component applications.

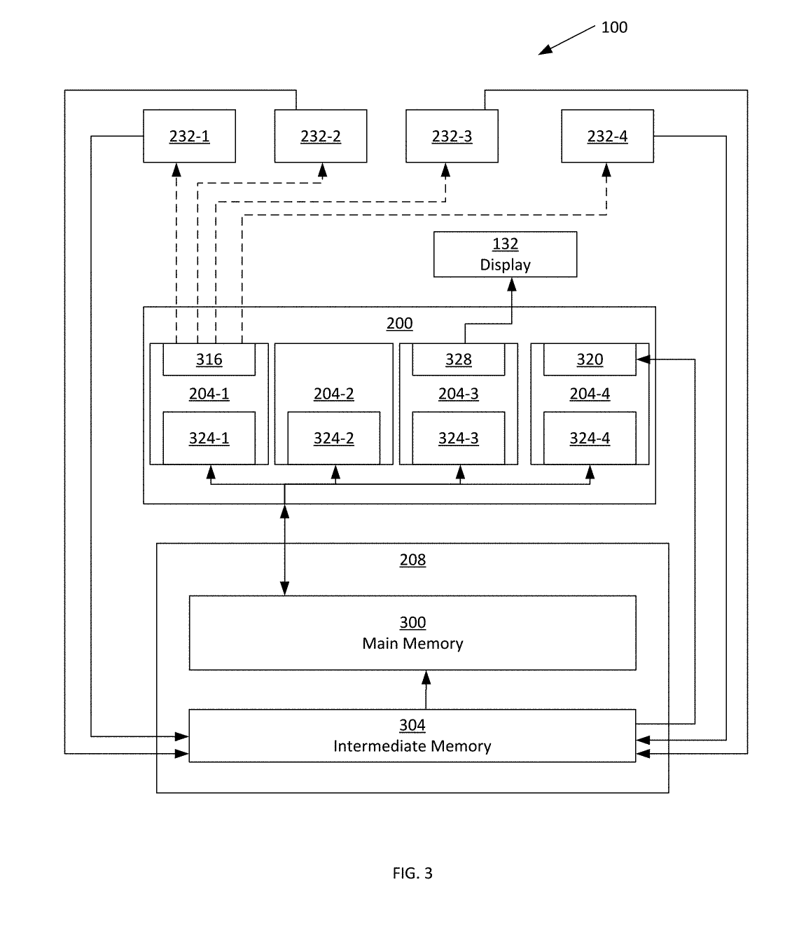

Turning now to FIG. 3, before describing the capture and decoding of images by the device 100, the above-mentioned components will be described in greater detail, according to certain examples. The input device 212 is omitted from FIG. 3 for simplicity.

The device 100 as illustrated in FIG. 3 includes a plurality of decoders 324-1, 324-2, 324-3 and 324-4, provided by the execution of instances (also referred to herein as decoder processes) of the decoder application 224 by the cores 204-1, 204-2, 204-3 and 204-4 of the processor 200, respectively. The device 100 also includes an imaging controller 316, provided by the execution of the imaging controller application 216 by the processor 200. The device 100 further includes a scheduler 320, provided by the execution of the scheduler application 220 by the processor 200, and a renderer 328, provided by the execution of the renderer application 228 by the processor 200.

In the illustrated example, the imaging controller 316, the renderer 328, and the scheduler 320 are implemented by the cores 204-1, 204-3 and 204-4, respectively. In other examples, however, the above-mentioned components can be provided via the execution of the corresponding applications by any one of, or any combination of, the illustrated processor cores 204. In further examples, a processor core 204 may be reserved (not shown) for the execution of one or more of the imaging controller application 216, the renderer application 228 and the scheduler application 220. The reserved core can be configured not to execute an instance of the decoder application 224.

In other examples, any one of, or any suitable combination of, the above-mentioned decoders 324, imaging controller 316, scheduler 320 and renderer 328 can be implemented by dedicated hardware components (e.g. one or more application-specific integrated circuits, or ASICs) rather than by execution of the respective applications 224, 216, 220 and 228 by general-purpose processing hardware. In further examples, the decoders 324, imaging controller 316, scheduler 320 and renderer 328 can be implemented as any suitable combination of dedicated hardware and computer-readable instructions executed by the processor 200.

As also shown in FIG. 3, the memory 208 includes a main memory 300 and an intermediate memory 304. The memory 208 also includes, in some examples, a non-volatile memory, not shown in FIG. 3, for data storage such as the storage of the applications 216, 220, 224 and 228 as shown in FIG. 2.

The main memory 300 may also be referred to as system memory, and is implemented as one or more random access memory devices interconnected with the processor 200. The intermediate memory 304 is implemented as a first-in, first-out (FIFO) memory device connected directly to the main memory 300. That is, the connection between the intermediate memory 304 and the memory 300 bypasses the processor 200. In some examples, the intermediate memory 304 is also connected to the processor 200 (in particular, to communicate with the scheduler 320, as will be discussed below). In the present example, the direct connection between the intermediate memory 304 and the main memory 300 is implemented via direct memory access (DMA), permitting the intermediate memory 304 to write data directly to the main memory 300 without oversight by the processor 200, and to inform the processor 200 (e.g. the scheduler 320) when the data transfer to the main memory 300 is complete. The above-mentioned notification is implemented as an interrupt request (IRQ) in the present example. As will now be apparent to those skilled in the art, the device 100 can therefore also include a direct memory access controller (not shown), such as an integrated circuit connected to the processor 200 and the memory 208.

The device 100 also includes direct connections (i.e. bypassing the processor 200) between the image sensors 232 and the intermediate memory 304. In other examples, the intermediate memory 304 is omitted, and the image sensors 232 are instead directly connected to the main memory 300 (e.g. via DMA). In further examples, the direct connections between the image sensors 232 and the memory 208 are omitted, and data transfer from the image sensors 232 and the memory 208 is instead handled by the processor 200.

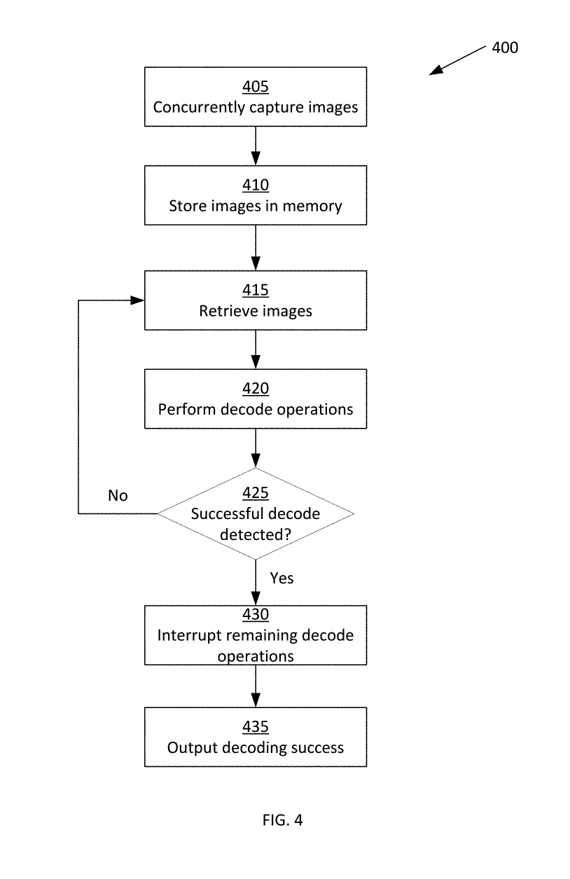

Turning now to FIG. 4, a method 400 of decoding at a data capture device is illustrated in accordance with the teachings of this disclosure. The method 400 is performed by the device 100; more specifically, portions of the method 400 are performed by certain components of the device 100, as will be discussed below.

At block 405, the device concurrently controls each of the image sensors 232 to capture respective images. In the present example, the imaging controller 316 is configured to detect an imaging command, such as an activation of the input device 212, and in response, to instruct the imaging sensors 232 to each begin capturing frames of image data. In the present example, the imaging controller 316 causes each imaging sensor 232 to begin capturing a stream of images, for example at a rate of fifty frames per second. In other examples, at block 405 the imaging controller 316 instead instructs each image sensor 232 to capture a single image.

For the purpose of illustration, in the present example performance of the method 400 it is assumed that the image sensors 232-1 and 232-2 have a different field of view than the image sensors 232-3 and 232-4. More specifically, referring briefly to FIG. 1, it is assumed that the image sensors 232-1 and 232-2 share a field of view that encompasses a portion of the face 124 of the box 116, while the image sensors 232-3 and 232-4 share a field of view that encompasses a portion of the face 120 of the box 116. Thus, upon receiving an instruction from the imaging controller 316, each image sensor 232 begins capturing a stream of images of the corresponding face of the box 116.

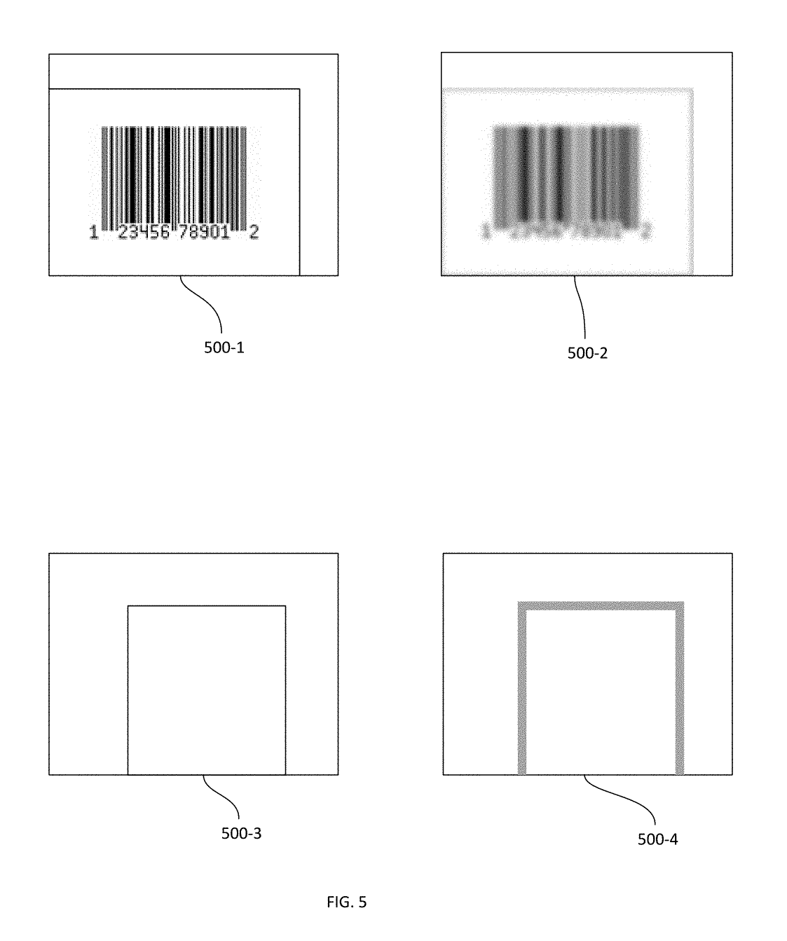

Turning to FIG. 5, a set of image data frames 500-1, 500-2, 500-3 and 500-4 (also simply referred to as images 500) are illustrated, captured concurrently by the image sensors 232-1, 232-2, 232-3 and 232-4 respectively. As seen in FIG. 5, the images 500-1 and 500-2 depict a portion of the box 116 as well as the indicium 128. However, the indicium 128 is out of focus in the image 500-2. In the present example, the image sensors 232-1 and 232-2 employ different image acquisition parameters, such as focal length. The difference in focal length between the image sensors 232-1 and 232-2 is fixed by the optical components of the data capture module 108 in some examples, and in other examples the focal length or any other combination of image acquisition parameters (e.g. lighting sensitivity) is controllable by the imaging controller 316.

The images 500-3 and 500-4 depict the face 120 of the box 116, and thus do not depict the indicium 128. Further, the image 500-4 depicts the face 120 out of focus, as the image sensors 232-3 and 232-4 are also assumed to have captured the images 500-3 and 500-4 employing different focal lengths, as discussed above in connection with the images 5001- and 500-2.

Returning to FIG. 4, at block 410 the device 100 is configured to store the images captured at block 405 in the memory 208. As will now be apparent to those skilled in the art, in the present example in which a stream of images are captured by the image sensors 232, the performance of blocks 405 and 410 is repeated for each set of images captured by the image sensors 232. Indeed, further performances of blocks 405 and 410 may be performed simultaneously with the performance of the remainder of the method 400.

The storage of the captured images at block 410, in general, results in the images 500 being stored in the main memory 300, where the images are accessible to the decoders 324. In the present example, the performance of block 410 includes transferring the captured images from the image sensors 232 to the intermediate memory 304. The intermediate memory 304 is then configured to transfer the images to the main memory 300. In some examples, the intermediate memory 304 is implemented as a dual-port memory device, and can therefore transfer images to the main memory 300 simultaneously with the receipt of other images from the image sensors 232.

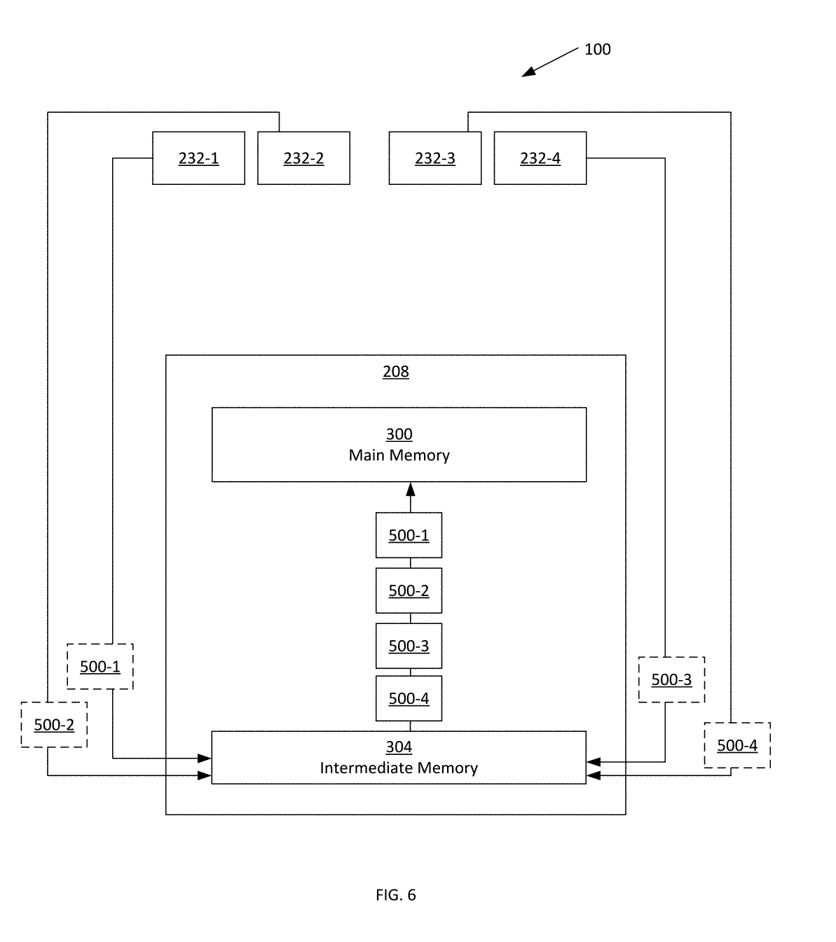

Referring to FIG. 6, in the present example, the intermediate memory 304 has distinct connections with each of the image sensors 232, and is configured to receive the images 500 substantially in parallel (as illustrated in dashed lines) from the image sensors 232. As noted earlier, in the present example there is a single connection between the main memory 300 and the intermediate memory 304, which is controlled by DMA transfers. Thus, having received the images 500, the intermediate memory 304 is configured to transfer the images 500 sequentially to the main memory 300 (as illustrated in solid lines in FIG. 6) via a series of DMA transfers. More specifically, the intermediate memory 304 is configured to select one of the images 500 for transfer, and to effect a DMA transfer of that image directly to the main memory 300.

In other examples, in which the intermediate memory 304 is omitted, block 410 is performed by transfer of the images 500 from the image sensors 232 directly to the main memory 300, e.g. via DMA transfers. However, the image sensors 232 are typically capable of lower data transfer rates than the intermediate memory 304, and any transfers to the main memory 300 are typically implemented sequentially. Therefore, direct transmission of the images 500 from the image sensors 232 to the main memory 300 may require more time to complete than the implementation shown in FIGS. 3 and 6 that includes the intermediate memory 304.

When each DMA transfer of an image 500 is complete, the intermediate memory 304 is configured to transmit an indication that the transfer is complete to the scheduler 320. As will now be apparent, when the intermediate memory 304 is omitted, such indications are provided to the scheduler 320 by the image sensors 232 themselves. In the present example, the indication is implemented as an IRQ that identifies the image and its location in the main memory 300. In some examples, the indication also identifies the sensor 232 that captured the image. The intermediate memory 304 repeats the above process until each of the images received substantially in parallel from the image sensors 232 have been transferred to the main memory 300. The intermediate memory 304 then awaits further images from the image sensors. It will be apparent to those skilled in the art that time required to transfer the set of images from the intermediate memory 304 to the main memory 300, even when performed sequentially as discussed above, is typically smaller than the time required for the image sensors 232 to capture the next set of frames.

Following the performance of block 410, the scheduler 320 has therefore received one indication for each image stored in the main memory 300 (i.e. four indications in the present example). The scheduler 320 is configured to store the indications, for example in a tabular format as shown below in Table 1.

TABLE 1
Scheduler Data

| Image/Sensor ID | Memory Location | Decoder Assignment |
|---|---|---|
| 500-1 | 0000000 | |
| 500-2 | 1000000 | |
| 500-3 | 2000000 | |
| 500-4 | 3000000 | |

As seen in Table 1, the scheduler 320 stores an identifier of each image received at the main memory 300 from the intermediate memory 304, which may also identify the image sensor 232 that captured the image. The scheduler 320 also stores a memory address identifying the location in the main memory 300 at which the corresponding image 500 is stored. Each record of Table 1 also includes a “decoder assignment” field, which is presently blank, and which is used further in the performance of the method 400 to track the allocation of the images 500 to the decoders 324.

Returning to FIG. 4, at block 415 the device 100, and more particularly the decoders 324, are each configured to retrieve respective ones of the images 500 from the main memory 300. In the present example, each decoder 324 is configured to request an image identifier from the scheduler 320. The scheduler 320 is configured to respond to such requests by transmitting one of the image identifiers and memory locations, received previously from the intermediate memory 304, to the requesting decoder 324. In other words, the scheduler 320 receives requests from each decoder 324 and allocates the available images 500 amongst the decoders 324. The scheduler 320 also, in the present example, updates the contents of Table 1 to reflect the above-mentioned allocation.

An example of the updated data maintained by the scheduler 320, including decoder assignments, is shown below in Table 2.

TABLE 2
Updated Scheduler Data

| Image/Sensor ID | Memory Location | Decoder Assignment |
|---|---|---|
| 500-1 | 0000000 | 324-2 |
| 500-2 | 1000000 | 324-1 |
| 500-3 | 2000000 | 324-3 |
| 500-4 | 3000000 | 324-4 |

In some examples, at block 415 the scheduler 320 is configured to initiate each decoder 324, for example by loading the decoder application 224 from the memory 208 and assigning instances of the decoder application 224 to at least a subset of the processor cores 204. The initiation of the decoders 324, when performed, precedes the retrieval of images from the main memory 300. Typically, the initiation process described above is performed only on startup of the device 100. In some examples, however, the decoders 324 may be terminated and re-initiated for every set of images captured by the image sensors 232.

Following initiation of the decoders 324 (if required) by the scheduler 320 and the receipt at the decoders 324 of image identifiers from the scheduler 320, each decoder 324 is configured to access the main memory 300 to retrieve the image 500 corresponding to the identifier received from the scheduler 320.

At block 420, the decoders 324 are configured to concurrently perform respective decode operations on the images retrieved from the main memory 300. Thus, in the present example, the decoder 324-2 is configured to perform a decode operation on the image 500-1, the decoder 324-1 is configured to perform a decode operation on the image 500-2, the decoder 324-3 is configured to perform a decode operation on the image 500-3, and the decoder 324-4 is configured to perform a decode operation on the image 500-4. The decode operations are based on any of a variety of known decoding libraries. In general, the decode operations attempt to identify machine-readable indicia in the images and decode any indicia so identified.

Each decoder 324 is configured to generate an indication of whether the decode operation performed by that decoder 324 was successful, upon completion of the decode operation. Each decoder 324 determines that the decode operation is complete when either data is successfully decoded from the image 500, or when a preconfigured time period elapses without any data being decoded. A variety of time periods may be employed, depending for example on the number of image sensors 232 and their capture rates, the number of decoders 324 employed, the processing speed of the processor 200, and the like. In the present example, the time period is twenty milliseconds, though it will be apparent to those skilled in the art that greater or smaller time periods can also be employed in other examples. Other conditions can be implemented for detecting failure. For example, in addition to or instead of the above-mentioned decoding time period, each decoder 324 may implement a shorter (e.g. ten milliseconds in some examples) preliminary time period during which, if no indicium is identified in the image, the decoder 324 determines that the decode operation has failed.

At block 425, the device 100, and more particularly the scheduler 320, is configured to detect whether any of the decoders 324 have successfully decoded data from an indicium in the images 500. That is, the scheduler 320 is configured to detect whether an indication has been received from a decoder 324 indicating that that particular decoder 324 has successfully decoded one of the images 500 retrieved at block 415.

When the determination at block 425 is negative, the performance of blocks 415-425 are repeated. That is, each decoder 324, upon determining that the decode operation has failed, is configured to send a failure indication to the scheduler 320, which in response provides the decoder 324 with an identifier and memory address of another image (recall that during the performance of blocks 415-425, further images are captured and committed to memory by the image sensors 232, under the control of the imaging controller 316). The decoder 324 retrieves the identified image in a further performance of block 415, and attempts to decode the image in a further performance of block 420. Thus, the decoders 324 may concurrently process a plurality of additional images, until an indicium in an image is successfully decoded. As will now be apparent, the scheduler 320 is configured to update the scheduler data shown in Tables 1 and 2 to reflect the receipt of additional images in the main memory 300, and the allocation of images to the decoders 324. When the decoding of a given image has failed, the scheduler 320 can delete the record corresponding to that image from the scheduler data (the image itself can also be deleted from the main memory 300).

When the determination at block 425 is affirmative, the scheduler 320 is configured to interrupt the decode operations performed by the remaining decoders 324—that is, the decoders 324 other than the decoder 324 that indicated a successful decode operation. The scheduler 320 is also configured, in some examples, to interrupt the capture of further images by the image sensors 232 (e.g. via an interrupt command to the imaging controller 316).

Referring to FIG. 5, decoding of the images 500-3 and 500-4 (allocated previously to the decoders 324-3 and 324-4) is likely to fail, as they do not contain any indicia to attempt to decode. When the decoders 324 implement the above-mentioned preliminary time period, the decoders 324-3 and 324-4 are likely to determine that their decode operations have failed at the end of that preliminary time period. The decoding of the image 500-2 by the decoder 324-1 is also likely to fail because the indicium 128 is out of focus in the image 500-2. However, detection of the failure to decode the image 500-2 may require the full decoding time period, as the indicium is sufficiently clear to be identifiable (although not decodable). Meanwhile, the decoding of the image 500-1 by the decoder 324-2 is likely to succeed.

When the decoder 324-2 informs the scheduler 320 that the image 500-2 has been successfully decoded, for example by sending an interrupt indicator to the scheduler 320, the scheduler 320 is configured to send interrupt commands to the decoders 324-1, 324-3 and 324-4. Those decoders, responsive to receiving the interrupt commands, are configured to cease the decode operations and discard the images 500. The scheduler 320 is configured to generate the interrupt command, for example, by retrieving the identifiers of each decoder 324 listed in the scheduler data (e.g. shown in Table 2) except the identifier of the decoder 324 that indicated a successful decode operation. The scheduler 320 is then configured to send the interrupt command to each of the decoders 324 whose identifiers were retrieved. In other examples, the scheduler 320 is configured to send the interrupt command to all other processes executing on the processor 200 that share a portion of a process name with the successful decoder. More specifically, because the decoders 324, in some examples, are instances of the same application (e.g. the decoder application 224), they are typically identified in a list of processes maintained at the processor 200 or in the main memory 300 by the same name, or by a set of names having the same base string. Therefore, the scheduler 320 can be configured to send the interrupt command to all processes having names containing that base string, regardless of whether those processes are represented in the scheduler data as having been allocated an image for decoding.

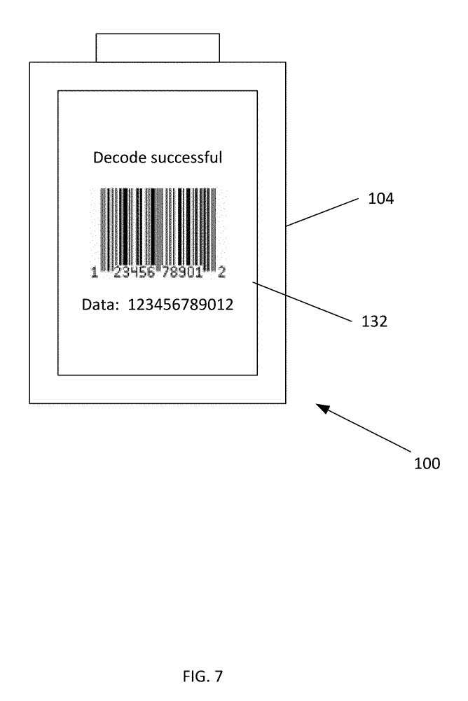

At block 435, the device 100 is configured to present, via an output device, an indication that an indicium has been successfully decoded. Turning to FIG. 7, in the present example the renderer 328 is configured to control the display 132 to present an indication including a text string (“decode successful”) indicating that an indicium has been decoded, as well as an image of the indicium itself, extracted from the image 500-1, and the data (“123456789012”) decoded from the indicium. As will be apparent to those skilled in the art, a wide variety of other indications can also be presented on the display 132, including sub-combinations of the three elements shown in FIG. 7. In further examples, the indication can be presented via an output device other than the display 132, such as a speaker.

The above description refers to block diagrams of the accompanying drawings. Alternative implementations of the examples represented by the block diagrams include one or more additional or alternative elements, processes and/or devices. Additionally or alternatively, one or more of the example blocks of the diagrams may be combined, divided, re-arranged or omitted. Components represented by the blocks of the diagrams are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations represented by the flowcharts of this disclosure). Some example logic circuits are hardware that executes machine-readable instructions to perform operations (e.g., one or more of the operations represented by the flowcharts of this disclosure). Some example logic circuits include a combination of specifically configured hardware and hardware that executes machine-readable instructions.

The above description refers to flowcharts of the accompanying drawings. The flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may be combined, divided, re-arranged or omitted. In some examples, the operations represented by the flowcharts are implemented by machine-readable instructions (e.g., software and/or firmware) stored on a medium (e.g., a tangible machine-readable medium) for execution by one or more logic circuits (e.g., processor(s)). In some examples, the operations represented by the flowcharts are implemented by one or more configurations of one or more specifically designed logic circuits (e.g., ASIC(s)). In some examples the operations of the flowcharts are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) can be stored. Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

As used herein, each of the terms “tangible machine-readable medium,” “non-transitory machine-readable medium” and “machine-readable storage device” is expressly defined as a storage medium on which machine-readable instructions are stored for any suitable duration of time (e.g., permanently, for an extended period of time (e.g., while a program associated with the machine-readable instructions is executing), and/or a short period of time (e.g., while the machine-readable instructions are cached and/or during a buffering process)).

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

1. A method of decoding at a data capture device, comprising:
concurrently controlling a plurality of image sensors of the data capture device to capture respective images, at least one of the images including an indicium encoding data;
storing the images in a memory of the data capture device;
concurrently retrieving some of the images from the memory;
performing respective decode operations on the some of the images;
responsive to detecting that the data has been successfully decoded from one of the images via one of the decode operations, interrupting remaining decode operations; and
responsive to determining that decode operations have failed, retrieving some other of the images from the memory, for decoding the some other of the image.

2. The method of claim 1, wherein performing the decode operations comprises executing an instance of a decoder process on each of a plurality of processor cores.

3. The method of claim 2, further comprising initiating each instance of the decoder process responsive to an indication that the storage of the images in the memory is complete.

4. The method of claim 2, wherein detecting that the data has been successfully decoded comprises detecting an interrupt indicator generated by the one of the decode operations.

5. The method of claim 1, further comprising:
responsive to the detecting, controlling the image sensors to interrupt capture of further images.

6. The method of claim 1, further comprising:
rendering an indication that the data has been successfully decoded on a display of the data capture device.

7. The method of claim 1, wherein storing the images in the memory comprises:
transmitting the images from the image sensors to an intermediate memory; and
transferring the images from the intermediate memory to a main memory.

8. The method of claim 7, wherein transmitting the images to the intermediate memory comprises transmitting the images in parallel; and wherein transferring the images to the main memory comprises transferring the images sequentially.

9. The method of claim 1, wherein controlling the image sensors comprises applying a first set of image acquisition parameters to a first one of the image sensors, and applying a second set of image acquisition parameters to a second one of the image sensors.

10. (canceled)

11. A data capture device, comprising:
a plurality of image sensors;
an imaging controller configured to concurrently control the plurality of image sensors of the data capture device to capture respective images, at least one of the images including an indicium encoding data;
a memory configured to store the images;
a plurality of decoders configured to:
concurrently retrieve some of the images from the memory;
perform respective decode operations on the some of the images;
a scheduler configured to:
responsive to detecting that the data has been successfully decoded from one of the images via one of the decode operations, interrupt remaining decode operations; and
responsive to determining that decode operations have failed, retrieve some other of the images from the memory, for decoding the some other of the image.

12. The data capture device of claim 11, further comprising:
a central processing unit including a plurality of processor cores;
the decoders comprising respective ones of the processor cores configured to perform the decode operations via execution of respective instances of a decoder process stored in the memory.

13. The data capture device of claim 12, the scheduler further configured to initiate each instance of the decoder process responsive to an indication that the storage of the images in the memory is complete.

14. The data capture device of claim 11, the scheduler configured to detect that the data has been successfully decoded by detecting an interrupt indicator generated by the one of the decoders.

15. The data capture device of claim 11, the scheduler further configured to interrupt capture of further images by the imaging controller.

16. The data capture device of claim 11, further comprising:
a display; and
a renderer configured to render an indication that the data has been successfully decoded on the display.

17. The data capture device of claim 11, the memory comprising:
an intermediate memory configured to receive the images from the image sensors; and
a main memory configured to receive the images from the intermediate memory.

18. The data capture device of claim 17, the intermediate memory configured to receive the images from the image sensors in parallel, and to transfer the images to the main memory sequentially.

19. The data capture device of claim 11, the imaging controller configured to apply a first set of image acquisition parameters to a first one of the image sensors, and to apply a second set of image acquisition parameters to a second one of the image sensors.

20. (canceled)
